(19) United States
(12) Patent Application Publication
(10) Pub. No.: US 2018/0285168 A1
(43) Pub. Date: Oct. 4, 2018

(54) INFORMATION PROCESSING APPARATUS AND INFORMATION PROCESSING SYSTEM

(71) Applicant: FUJITSU LIMITED, Kawasaki-shi (JP)

(72) Inventors: Fumihiko Kono, Nagoya (JP); Shinichi Kameyama, Iwakura (JP); Atsushi Tashiro, Nagoya (JP); Tomoshi Takagawa, Nagoya (JP); Minoru MAEDA, Nagoya (JP)

(73) Assignee: FUJITSU LIMITED, Kawasaki-shi (JP)

(21) Appl. No.: 15/877,426

(22) Filed: Jan. 23, 2018

(30) Foreign Application Priority Data
Mar. 28, 2017 (JP) 2017-063772

(51) Int. Cl. G06F 9/50; G06F 9/48; G06F 9/455

(52) U.S. Cl. CPC G06F 9/5088; G06F 9/45558; G06F 9/5077; G06F 9/4856

(57) ABSTRACT

An information processing apparatus is included in an information processing system, constructed with a plurality of information processing apparatuses and configured to aggregate state information indicating a state of each of the plurality of information processing apparatuses which is acquired by the each information processing apparatus. The information processing apparatus includes a memory and a processor coupled to the memory and configured to: transmit the state information of the each information processing apparatus to a first information processing apparatus which is one of the plurality of information processing apparatuses; and transmit the state information of the each information processing apparatus to a second information processing apparatus different from the first information processing apparatus among the plurality of information processing apparatuses, when a notification indicating that an aggregation process of aggregating the state information of the each information processing apparatus is not executable is received from the first information processing apparatus.

### CROSS-REFERENCE TO RELATED APPLICATION

This application is based upon and claims the benefit of priority of the prior Japanese Patent Application No. 2017-063772, filed on Mar. 28 2017, the entire contents of which are incorporated herein by reference.

### FIELD

The embodiment discussed herein are related to an information in processing apparatus, an information processing system, and a computer-readable recording medium having stored therein an information processing program.

### BACKGROUND

In the related art, there is a case where one system is constructed with a plurality of information processing apparatuses. In addition, there is a case where state information of the plurality of information processing apparatuses is collected, aggregated, and stored in a storage area of a certain information processing apparatus.

As the related art, for example, load information of a plurality of collecting apparatuses is acquired based on collecting apparatus information for identifying a collecting apparatus that collects state information, a collecting apparatus is selected based on the load information, and monitoring apparatus information for identifying a monitoring apparatus is notified to the selected collecting apparatus. In addition, there is a technology in which, in a plurality of database (DB) servers distributed/arranged on a plurality of nodes, loads of the respective nodes, are monitored and balanced by moving a connection from a DB server on a node having a load higher than a target load to a OB server on a node having a load lower than the target load. There is a technology of calculating indexes indicating operation statuses of a plurality of server groups from information obtained from an external network, a load management device, an internal network and others, and controlling the states of the plurality of server groups based on the calculated indexes. In addition, there is a technology of receiving a request from a basic part, determining which of a client or a server will execute a server component, to acquire the server component, and guiding the server component to the client or the server according to the determination result.

Related technologies are disclosed in, for example, Japanese Laid-Open Patent Publication No. 2012-194835, International Publication Pamphlet No. WO 2012/70292, and Japanese Laid-Open Patent Publication Nos, 2011-210225 and 2000-076172.

### SUMMARY

According to an aspect of the embodiments, an information processing apparatus is included in an information processing system which is constructed with a plurality of information processing apparatuses and configured to aggregate state information indicating a state of each of the plurality of information processing apparatuses which is acquired by the each information processing apparatus. The information processing apparatus includes a memory and a processor coupled to the memory and configured to: transmit the state information of the each information processing apparatus to a first information processing apparatus which is one of the plurality of information processing apparatuses; and transmit the state information of the each information processing apparatus to a second information processing apparatus different from the first information processing apparatus among the plurality of information processing apparatuses, when a notification indicating that an aggregation process of aggregating the state information of the each information processing apparatus is not executable is received from the first information processing apparatus.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is an explanatory view illustrating an example of an operation of an information processing system according to an embodiment of the present disclosure;

FIG. 2 is an explanatory view lustrating an example of use of the information processing system;

FIG. 3 is an explanatory view illustrating an example of a hardware configuration of a node;

FIG. 4 is an explanatory view illustrating an example of functional configuration of the information processing system;

FIG. 5 is an explanatory view illustrating an example of stored contents of a time-series database (DB);

FIG. 6 is a flowchart illustrating a procedure of a process by an acquisition unit;

FIG. 7 is an explanatory view (part 1) illustrating an example of an operation of the process by the acquisition unit;

FIG. 8 is an explanatory view (part 2) illustrating an example of an operation of the process by the acquisition unit;

FIG. 9 is a flowchart illustrating a procedure of a process of updating the number of receivable performance information by a child aggregation unit;

FIG. 10 is an explanatory view illustrating an example of an operation of the process of updating the number of receivable performance information by the child aggregation unit;

FIG. 11 is a flowchart illustrating a procedure of a process of receiving performance information by the child aggregation unit; and

FIG. 12 is an explanatory view illustrating an example of an operation of the process of receiving performance information by the child aggregation unit.

### DESCRIPTION OF EMBODIMENTS

According to the related art, when distributing a load of an aggregation process of aggregating state information of each of the plurality of information processing apparatuses, it becomes difficult to determine an information processing apparatus for executing the aggregation process as the number of the information processing apparatuses increases. For example, when a load of each information processing apparatus is referred to as an index to determine an information processing apparatus for executing the aggregation process, information indicating the load of each information processing apparatus is stored in a storage area of a certain information processing apparatus. Thus, as the number of the information processing apparatuses increases, the number of accesses to the storage area described above increases, and the load of the certain information processing apparatus increases.

Hereinafter, embodiments of an information processing apparatus, an information processing system, and a non-transitory computer-readable recording medium having stored therein an information processing program of the present disclosure will be described in detail with reference to the drawings.

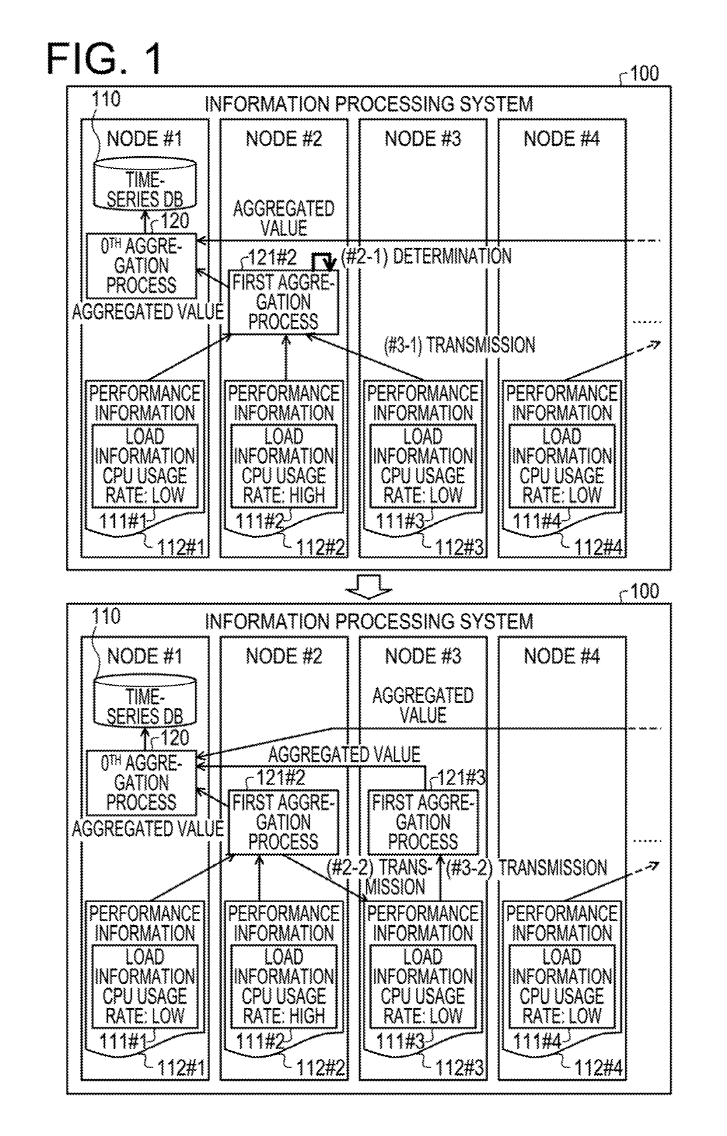

FIG. 1 is an explanatory view illustrating an example of an operation of an information processing system 100 according to an embodiment of the present disclosure. The information processing system 100 is constructed with a plurality of information processing apparatuses by a technique called software defined storage (SDS). Here, the SDS has attracted attention because, as measurement information is acquired from various terminals with the popularization of the Internet of things (IoT), a data amount increases, and the SDS is capable of flexibly coping with the increase of data.

Each information processing apparatus is, for example, a computer such as a server or a storage device. Hereinafter, the information processing apparatus will be referred to as a “node.” In the information processing system 100, a distributed architecture which regards a plurality of nodes as one storage device may be applied. In addition, the information processing system 100 is capable of improving its performance by scale-out.

The distributed architecture may have a performance monitoring function using a time-series DB storing state information of each of the plurality of nodes. For example, the performance monitoring function executes collecting, accumulating, and referring to the state information of each node. In addition, one of the plurality of nodes has the time-series DB. The node having the time-series DB will be referred to as a “representative node.” In principle, the representative node does not change during the operation of the information processing system 100. However, for example, when the representative node malfunctions, another node may become a representative node.

The state information of each node includes performance information, configuration information, or process information of each node. The performance information of each node is, for example, a central processing unit (CPU) usage rate, a network usage rate, input/output per second (IOPS), or a disk usage rate. The configuration information of each node indicates a configuration of physical resources of each node or a configuration of a virtual machine operating on each node. The process information of each node indicates a progress status of, for example, a copying process of each node. The state information of each node may be obtained by, for example, a stat call prepared by an OS, or file reference. Hereinafter, for the simplification of descriptions, descriptions will be made assuming that the state information of each node corresponds to the performance information of each node.

Here in an actual system, the performance information which is stored in the time-series DB per unit time may amount to several thousands to several hundreds of thousands of units, for both physical resources and virtual resources. In this case, when an aggregated value of the performance information per time such as a total value or an average value, for example, information of total or average IOPS of all disks is calculated each time the information is referred to, a process load and time increase, and further, the frequency of reference to the aggregated value is relatively high.

For example, with respect to the aggregated value, a method may to be taken into account to cause the representative node to aggregate the performance information of each node and store the information in the time-series DB. Thus, the time-series DB stores a process result of an aggregation process of calculating the aggregated value. However, in this method, since the representative node collects the performance information of all aggregation targets and executes the aggregation process, the CPU or network of the representative node becomes a bottleneck, which may affect a normal work such as disk writing.

Thus, a method may be taken into account to distribute the aggregation process of calculating the aggregated value so as to distribute the load to the plurality of nodes. However, in this method, it becomes difficult to determine a node for executing the aggregation process as the number of the nodes increases. For example, when the time-series DB is referred to as an index to determine a node for executing the aggregation process, the access to the time-series DB increases as the number of the nodes increases, and thus, the load of the representative node increases.

In addition, a method may be taken into account to change a node for executing the aggregation process in the round-robin manner each predetermined time. However, in this method, even when a node having a relatively low load is determined to execute the aggregation process, the node for executing the aggregation process is changed after elapse of predetermined time. Thus, the node for executing the aggregation process may be changed to a node having a relatively high load. In this case, the normal work may be affected.

Thus, in the present embodiment, when each node transmits performance information to a certain node and receives a notification indicating that an aggregation process is not executable, the transmitting node transmits the performance information to a node other than the certain node.

An example of an operation of the information processing system 100 will be described using FIG. 1. The information processing system 100 to illustrated in FIG. 1 is constructed with nodes #1, #2, #3, #4, . . . as a plurality of nodes. In this way, each node may be associated with a number for identifying the node. Hereinafter, a number associated with a node will be simply referred to as a “node number”. Further, in the descriptions below, a reference numeral assigned with “#x” refers to a component related to a node #x. The symbol “x” indicates a node number of a node, and is a natural number. In addition, when the same kind of components are not discriminated, a reference numeral which is not assigned with “#x” may be used. In FIG. 1, a thick arrow indicates an instruction or a process to another node, and an ordinary arrow indicates transmission of performance information or an aggregated value.

As illustrated in FIG. 1, since a node #1 has a time-series DB 110, the node #1 becomes the representative node. In addition, the information processing system 100 aggregates performance information 112 of each node. Here, the performance information 112 may include load information 111 indicating a load of each node. The load information 111 is, for example, a CPU usage rate or a network usage rate. In the example of FIG. 1, it is assumed that the load information 111 is a CPU usage rate.

In the upper part of FIG. 1, the aggregation process is distributed to a 0th aggregation process 120 and a first aggregation process 121. The node #1 serving as the representative node executes the 0th aggregation process 120, and the node #2 executes the first aggregation process 121,

Although omitted in FIG. 1, one of the node #4 and the subsequent nodes executes the first aggregation process 121.

The first aggregation process 121 collects performance information 112#1 to 112#3 of the nodes #1 to #3 which are aggregation targets, and transmits the aggregated value to the node #1 executing the 0th aggregation process 120. The 0th aggregation process 120 further aggregates the aggregated value transmitted from the first aggregation process 121, and stores the obtained aggregated value in the time-series DB 110. In FIG. 1, descriptions will be made assuming that the CPU usage rate of the node #2 becomes high. In addition it is assumed that the CPU usage rates of the nodes #1, #3, and #4 are low.

In the upper part of FIG. 1, the nodes #1 and #2 transmit the performance information 112#1 and 112#2, respectively, to the node #2, and then, the node #3 transmits the performance information 112#3 to the node #2 as a first node which is one of the plurality of nodes, as indicated in (#3-1) of FIG. 1. A second node is indicated in the lower part of FIG. 1. In addition, the first node may be an own node.

The node #2 receives the performance information 112#3 of the node #3 as a third node which is one of the plurality of nodes. In this case, as indicated by (#2-1) of FIG. 1, the node #2 determines whether the first aggregation process 121#2 of aggregating the performance information 112#3 is executable, based on the number of the performance information 112 receivable to execute the first aggregation process 121#2 and the number of the received performance information 112. The number, of the performance information 112 receivable to execute the first aggregation process 121#2 will be referred to as the “number of receivable performance information.” The number of receivable performance information may be a value corresponding to a load of a node at the time when the performance information 112 is received. For example, each node may store the number of receivable performance information for each own load, For example, each node may have a table storing the number of receivable performance information for each load in which the CPU usage rate is 10[%], 20[%], . . .

Alternatively, each node may calculate the number of receivable performance information based on a difference between an average value of the loads of all the nodes and its own load. As to the average value of the loads of all the nodes, for example, the representative node may periodically transmit the average value of the loads of all the nodes to each node.

In the example of the upper part of FIG. 1, it is assumed that the load of the node #2 is high, the number of the receivable performance information is 2, and the number of the received performance information 112 is 3. In this case, the node #2 determines that the first aggregation process 121#2 of aggregating the performance information 112#3 is not executable.

When it is determined that the first aggregation process 121#2 of aggregating the performance information 112#3 is not executable, a notification indicating that the first aggregation process 121#2 of aggregating the performance information 112#3 is not executable is transmitted as indicated in (#2-2) of FIG. 1. Hereinafter, the notification indicating that the first aggregation process 121#2 is not executable will be referred to as “unreceivable.”

Then, upon receiving the notification of “unreceivable” from the node #2, the node #3 transmits the performance information 112#3 to a second node different from the node #2 which is the first node among the plurality of nodes, as indicated in (#3-2) of FIG. 1. The second node may be any node which is different from the first node. However, the second node may be a node whose node number is next or previous to that of the first node. In addition, the second node may be an own node. In the example of the lower part of FIG. 1, the node #3 transmits the performance information 112#3 to the node #3 which is its own node. Then, the node #3 executes the first aggregation process 121#3 of aggregating the performance information 112#3, and transmits the aggregated value which is the process result, to the node #1.

In this way, in the information processing system 100, each node is capable of dynamically changing a node for executing the first aggregation process 121. Thus, the information processing system 100 may suppress concentration of a bad on one node. Further, the information processing system 100 may suppress the influence on the normal work due to the concentration of the transmission of the performance information 112 on a node having a high load, when the load of each node increases or decreases due to the normal work.

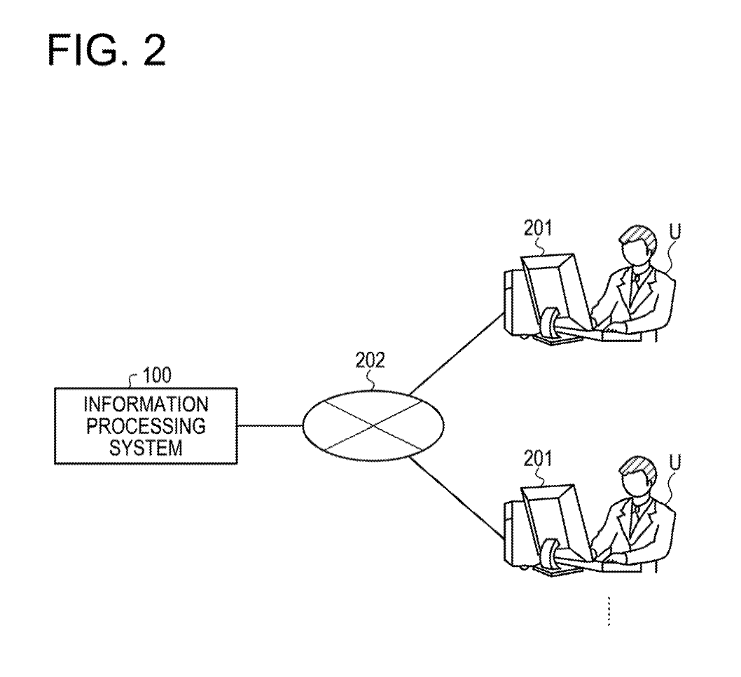

In addition, in (#3-2) of FIG. 1, the node #3 transmits the in performance information 112#3 to the second node when the notification of “unreceivable” is received from the node #2. However, the present disclosure is not limited thereto. For example, the node #3 may transmit the performance information 112#3 to the second node when the communication with the node #2 is impossible. As a result, the information processing system 100 may is minimize the influence of the decrease of nodes caused from a disaster or the like. Next, an example of use of the information processing system 100 will be described using FIG. 2.

FIG. 2 is an explanatory view illustrating an example of use of the information processing system 100. As illustrated in FIG. 2, the information processing system 100 is connected to a user terminal 201 and a network 202 such as the Internet, a local area network (LAN), or a wide area network (WAN).

The user terminal 201 is a computer operated by a user U using the information processing system 100. The user terminal 201 is, for example, a PC. For example, each node in the information processing system 100 operates a business system, and the user U accesses the information, processing system 100 by operating the user terminal 201, so as to perform the business using the business system.

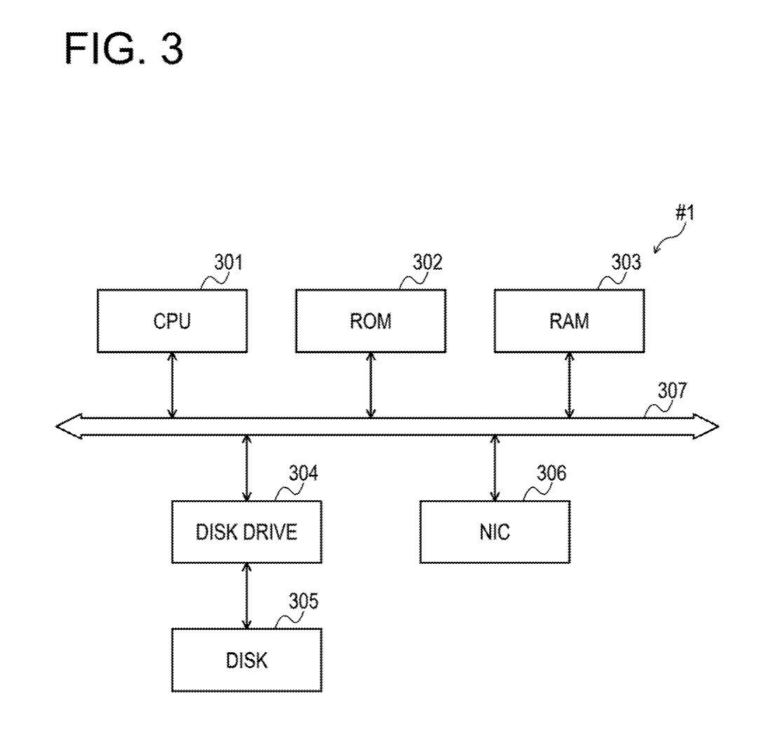

Next, an example of a hardware configuration of the node #1 included in the information processing system 100 will be described using FIG. 3. Since the hardware of each node other than the node #1 also is the same as the hardware of the node #1, descriptions thereof will be omitted.

FIG. 3 is an explanatory view illustrating an example of a hardware configuration of the node #1. In FIG. 3, the node #1 includes a CPU 301, a read-only memory 302, and a random access memory (RAM) 303. Further, the node #1 includes a disk drive 304, a disk 305, and a network interface card (NIC) 306. In addition, the CPU 301, the ROM 302, the RAM 303, the disk drive 304, and the NIC 306 are connected to each other via a bus 307.

The CPU 301 is an arithmetic processor that controls the entire node #1. The ROM 302 is a nonvolatile memory that stores a program such as a boot program. The RAM 303 is a volatile memory used as a work area of the CPU 301.

The disk drive 304 is a control device that controls reading and writing of data with respect to, the disk 305 under the control by the CPU 301. As the disk drive 304, for example, a magnetic disk drive, an optical disk drive or a solid state drive may be adopted. The disk 305 is a nonvolatile memory that stores data written under the control by the disk drive 304, For example, when the disk drive 304 is a magnetic disk drive, a magnetic disk may be adopted as the disk 305. In addition, when the disk drive 304 is an optical disk drive, an optical disk may be adopted as the disk 305. In addition, when the disk drive 304 is a solid state drive, a semiconductor memory formed by a semiconductor element, that is, a so-called semiconductor disk may be adopted as the disk 305.

The NIC 306 is a control device that serves as an internal interface with the network 202 and controls input and output of data from other devices. Specifically, the NIC 306 is connected to another device via the network 202 through a communication line. As for the NIC 306, for example, a LAN adapter may be adopted.

In addition, when a manager of the information processing system 100 directly operates the node #1, the node #1 may have hardware such as a display, a keyboard, and a mouse.

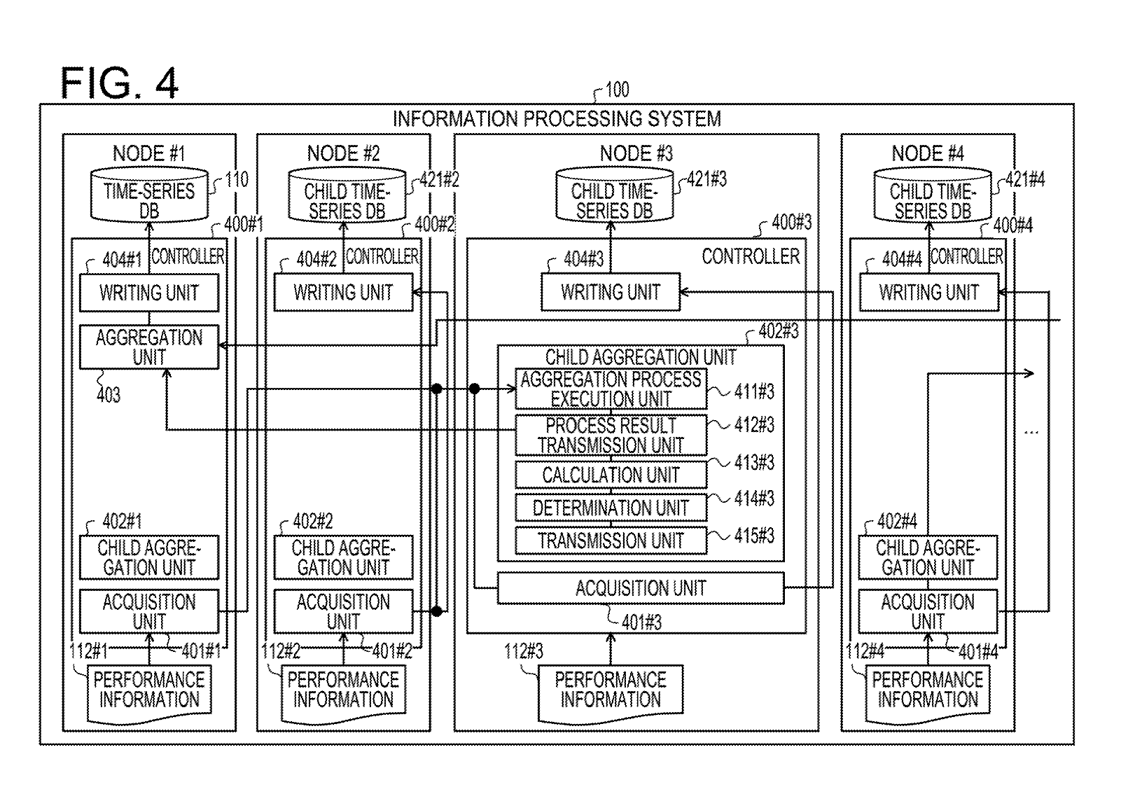

FIG. 4 is an explanatory view illustrating an example of a functional configuration of the information processing system 100. Each node has a controller 400. The controller 400 includes an acquisition unit 401, a child aggregation unit 402, and a writing unit 404. In addition, the controller 400 of the representative node further includes an aggregation unit 403. The controller 400 implements the functions of the respective units in the manner that the CPU 301 executes programs stored in a storage device. Specifically, the storage device is, for example, the ROM 302, the RAM 303 or the disk 305 illustrated in FIG. 3. The process results of the respective units are stored in to the RAM 303, a register of the CPU 301, a cache memory of the CPU 301 or the like.

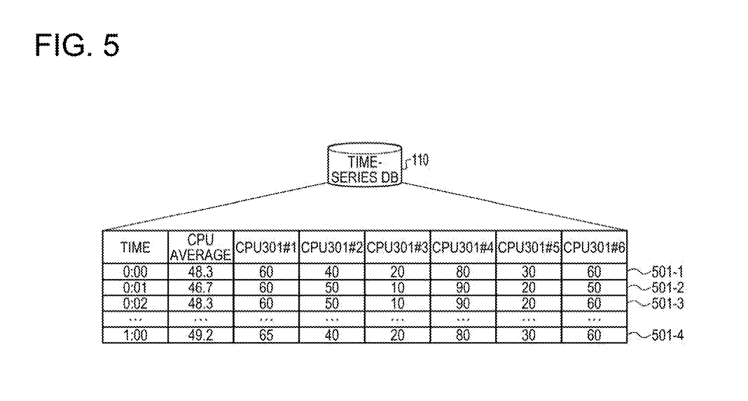

The representative node has the time-series DB 110. FIG. 5 illustrates an example of stored contents of the time-series DB 110. In addition, each node other than the representative node has a child time-series DB 421. The child time-series DB 421 stores the performance information 112 itself of its own node.

The acquisition unit 401 acquires the performance information 112 such as a CPU usage rate, IOPS, and a disk usage rate by a stat system call or file reference at regular time intervals. Then, the acquisition unit 401 of each node other than the representative node transmits the acquired performance information 112 itself to the writing unit 404.

Further, the acquisition unit 401 transmits the acquired performance information 112 to the first node which is one of the plurality of nodes. Then, when the notification of “unreceivable” is received from the first node, the acquisition unit 401 transmits the acquired performance information 112 to the second node different from the first node, among the plurality of nodes. Here, the second node may be a node whose node number is next or previous to that of the first node.

The child aggregation unit 402 calculates a total value or an average value of a part of the performance information at each time, and transmits the calculation result to the aggregation unit 403. Specifically, the child aggregation unit 402 includes an aggregation process execution unit 411, a process result transmission unit 412, a calculation unit 413, a determination unit 414, and a transmission unit 415. Although FIG. 4 illustrates that the child aggregation unit 402#3 includes the aggregation process execution unit 411 to the transmission unit 415, each of the other child aggregation units 402 also includes the aggregation process execution unit 411 to the transmission unit 415.

The aggregation process execution unit 411 aggregates the performance information 112 transmitted from the acquisition unit 401. For example, the aggregation process execution unit 411 calculates a total value or an average value as an aggregated value of the performance information 112. The aggregation process execution unit 411 corresponds to the first aggregation process 121 illustrated in FIG. 1. In addition, the aggregation unit 403 corresponds to the 0th aggregation process 120 illustrated in FIG. 1.

The process result transmission unit 412 transmits the result of the process by the aggregation process execution unit 411 to the aggregation unit 403.

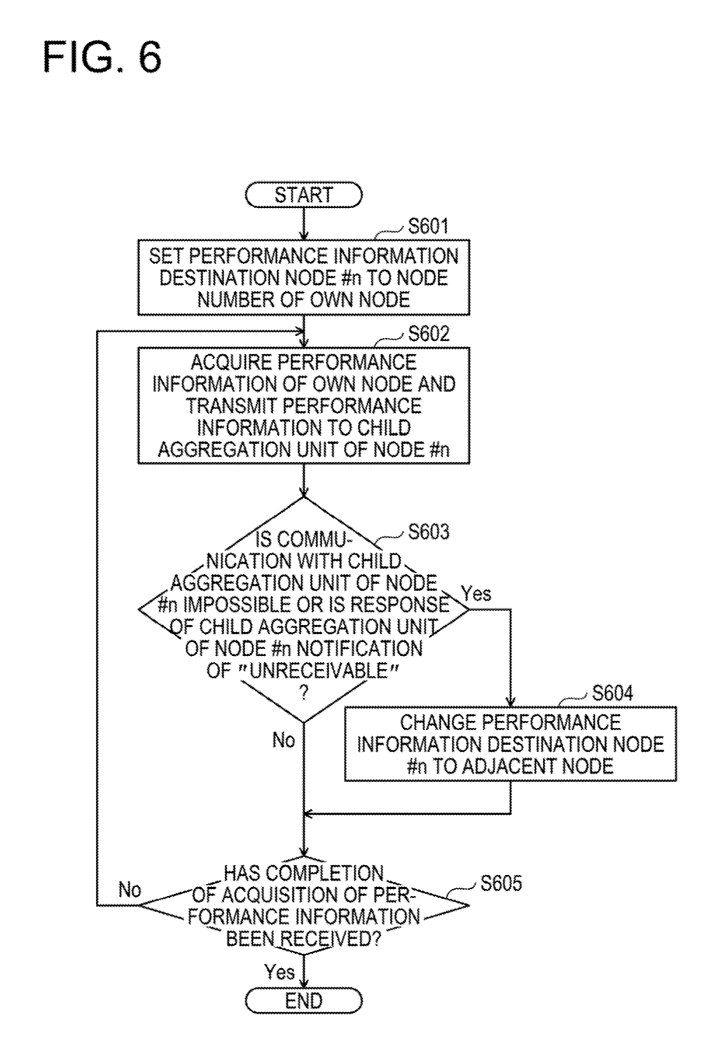

The calculation unit 413 calculates the number of receivable performance information. Specifically, the calculation unit 413 receives an average value of the loads of the plurality of nodes from the representative node. Then, the calculation unit 413 calculates the number of receivable performance information based on a difference between the average value of the loads of the plurality of nodes and the load of its own node. For example, the calculation unit 413 may calculate a value obtained by dividing a difference between an average value of the CPU usage rates of the plurality of nodes and the CPU usage rate of the own node by a CPU usage rate for aggregation of one piece of performance information 112, as the number of receivable performance information. FIG. 6 illustrates the more specific calculation method.

As to the determination unit 414, it is assumed that the determination unit 414 receives the performance information 112 of the third node which is one of the plurality of nodes, from the third node. In this case, the determination unit 414 determines whether the aggregation process of aggregating the performance information 112 of the third node is executable, based on the number of receivable performance information at the receiving time of the performance information 112 of the third node, and the number of the received performance information 112. Here, the number of receivable performance information at the receiving time of the performance information 112 of the third node may be a value calculated by the calculation unit 413. Alternatively, the calculation unit 413 may acquire the number of receivable performance information which corresponds to the load of its own node at the receiving time of the performance information 112 of the third node, by referring to the table storing the number of receivable performance information according to the load of the own node.

When it is determined that the aggregation process of aggregating the performance information 112 of the third node is not executable, the, transmission unit 415 transmits the notification of “unreceivable” to the third node.

The aggregation unit 403 calculates a total value or an average value of the performance information 112 for all the plurality of nodes at each time, from the aggregation result from the child aggregation unit 402, and transmits the aggregation result to the writing unit 404.

The writing unit 404 of the representative node writes the aggregated value from the aggregation unit 403 in the time-series DB 110 in association with time information. In addition, the writing unit 404 of each node other than the representative node writes the performance information 112 of each node in the child time-series DB 421 in association with time information.

FIG. 5 is an explanatory view illustrating an example of stored contents of the time-series DB 110. In the time-series DB 110 illustrated in FIG. 5, information on a CPU usage rate is stored. In addition, the time-series DB 110 illustrated in FIG. 5 has records 501-1 to 501-4.

Specifically, the time-series DB 110 illustrated in FIG. 5 includes fields for time, a CPU average, and each CPU usage rate. Here, in FIG. 5, the field for each CPU usage rate describes merely a code of the CPU of each node, for the simplification of illustration. The field for time stores time when a CPU usage rate is measured. The field for a CPU average stores an average value of all CPU usage rates in the information processing system 100. The field for each CPU usage rate stores a usage rate of each CPU.

In addition, the time-series DB 110 may store information on a network. When information on a network is stored, the time-series DB 110 includes fields for time, an NIC average, and each NIC usage rate. The field for time stores time when a network usage rate is measured. The field for an NIC average stores an average value of all NIC usage rates in the information processing system 100. The field for each NIC usage rate stores a usage rate of each NIC.

(Process of Acquisition Unit 401)

Next, the process executed by the acquisition unit 401 be described using FIGS. 6 to 8.

FIG. 6 is a flowchart illustrating a procedure of the process by the acquisition unit 401. The acquisition unit 401 sets a performance information transmission destination node #n to a node number of its own node (step S601).

Next, the acquisition unit 401 acquires the performance information of its own node and transmits the performance information to the child aggregation unit 402 of the node #n (step S602).

Then, the acquisition unit 401 determines whether a communication with the child aggregation unit 402 of the node #n is impossible, or a response of the child aggregation unit 402 of the node #n is the notification of “unreceivable” (step S603). When it is determined that a communication with the child aggregation unit 402 of the node #n is impossible or a response of the child aggregation unit 402 of the node #n is the notification of “unreceivable” (step S603: “Yes”), the acquisition unit 401 changes the performance information transmission destination node #n to an adjacent node (step S604). Specifically, the acquisition unit 401 changes the performance information transmission destination node #n to an adjacent node, by executing the following equation (1).

n=(n mod the number of nodes of the information processing system 100)+1 (1)

Here, “mod” indicates a calculation acquiring a remainder of a division. For example, when the number of the information processing systems 100 is 6, and n=6, the acquisition unit 401 updates “n” by using the equation (1) to as follows:

n=(6 mod 6)+1=0+1=1

Meanwhile, when it is determined that a communication with the child aggregation unit 402 of the node #n is possible, and a response of the child aggregation unit 402 of the node #n is not the notification of “unreceivable” (step S603: “No”), or after the process of step S604 is ended, the acquisition unit 401 determines whether completion of the acquisition of the performance information has been received from the user terminal 201 (step S605). When it is determined that completion of the acquisition of the performance information has not been received from the user terminal 201 (step S605: “No”), the acquisition unit 401 proceeds to the process of step S602 for performance information at the next time. Meanwhile, when it is determined that completion of the acquisition of the performance information has been received from the user terminal 201 (step S605: “Yes”), the acquisition unit 401 ends the series of processes.

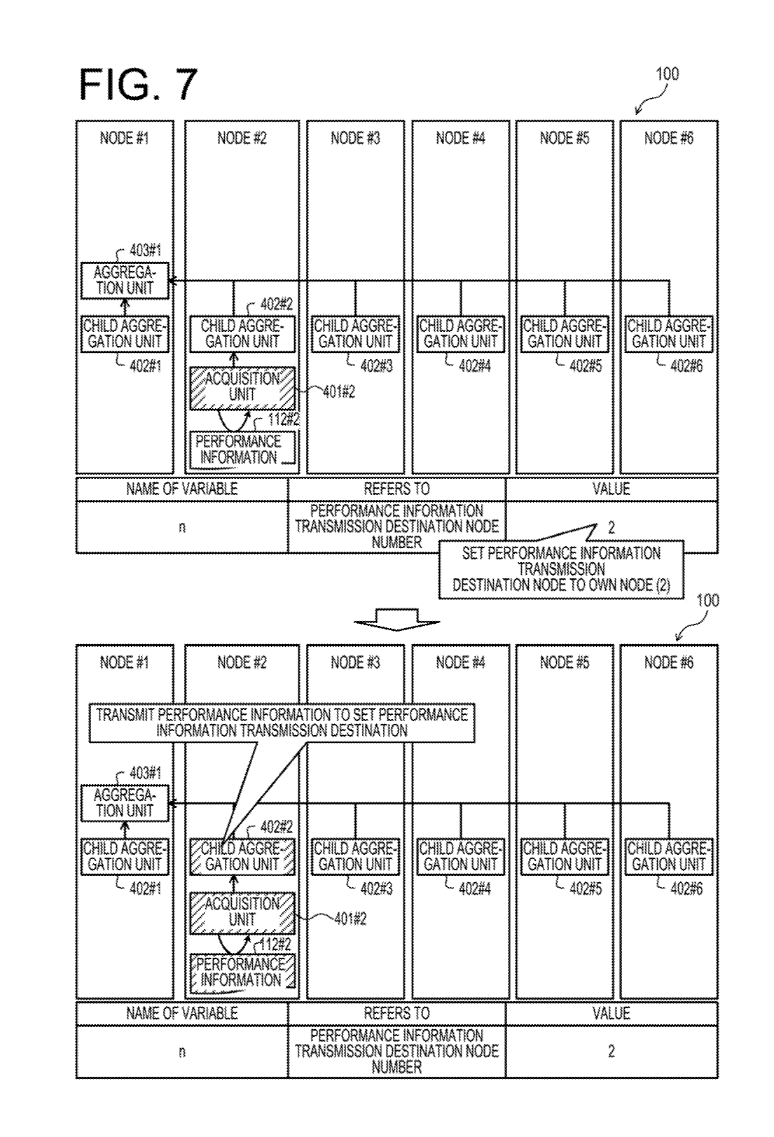

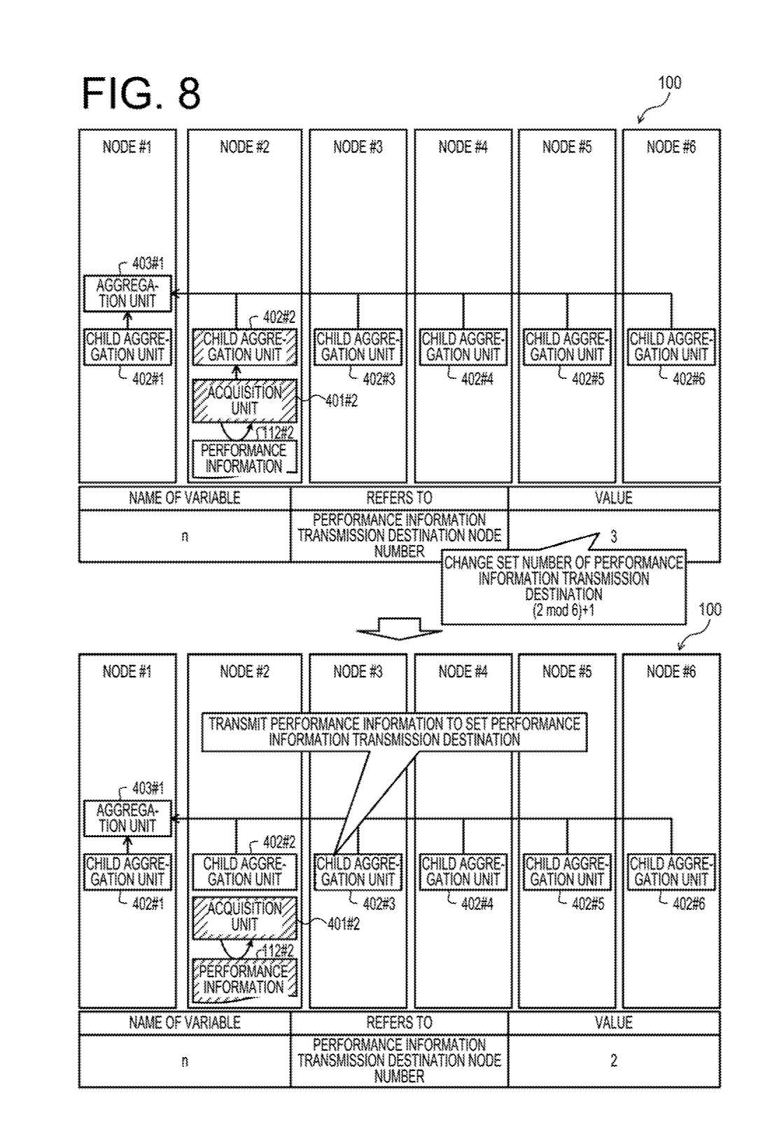

Next, an example of a specific operation of the process by the acquisition unit 401 as illustrated in FIG. 6 will be described using FIGS. 7 and 8.

FIG. 7 is an explanatory view (part 1) illustrating an example of an operation of the process by the acquisition unit 401. FIG. 8 is an explanatory view (part 2) illustrating an example of an operation of the process by the acquisition unit 401. FIGS. 7 and 8 represent an example where the acquisition unit 401#2 executes the process of the acquisition unit 401 illustrated in FIG. 6, Further, in FIGS. 7 and 8, the acquisition unit 401#2 which is a process subject and the functional units or data which are process targets are indicated in white texts with black backgrounds.

The upper part of FIG. 7 represents the state of the information processing system 100 when the acquisition unit 401#2 executes the process of step S601. The acquisition unit 401#2 sets the node number “n” of the performance information transmission destination node #n to the node number “2” of its own node. The lower part of FIG. 7 represents the state of the information processing system 100 when the acquisition unit 401#2 executes the process of step S602. The acquisition unit 401#2 acquires the performance information 112#2 and transmits the acquired performance information to the set performance information destination, that is, the child aggregation unit 402#2 of the node #2 in this case.

The upper part of FIG. 8 illustrates the state of the information processing system 100 when a communication with the child aggregation unit of the node #n is impossible or a response of the child aggregation unit of the node n is the notification of “unreceivable,” and the acquisition unit 401#2 executes the process of step S604. The case of executing the process of step S604 indicates a case where the child aggregation unit 402 of the transmission destination is unable to receive performance information due to a load status or the like. Thus, the process of step S604 indicates a process of changing the performance information transmission destination to the child aggregation unit 402 of an adjacent node when the load of the child aggregation unit 402 of the transmission destination is high. Specifically, the acquisition unit 401#2 executes the equation (1) as follows:

n=(2 mod 6)+1=3

As described above, since n=3, the acquisition unit 401#2 updates update “n” to 3.

The lower part of FIG. 8 represents the state of the information processing system 100 when the acquisition unit 401#2 executes the process of step S604, the answer of the step S605 is “No,” and the acquisition unit 401#2 executes the process of step S602 again. The acquisition unit 401#2 acquires the performance information 112#2 and transmits the acquired performance information to the set performance information destination, that is, the child aggregation unit 402#3 of the node #3 in this case.

(Process by Child Aggregation Unit 402)

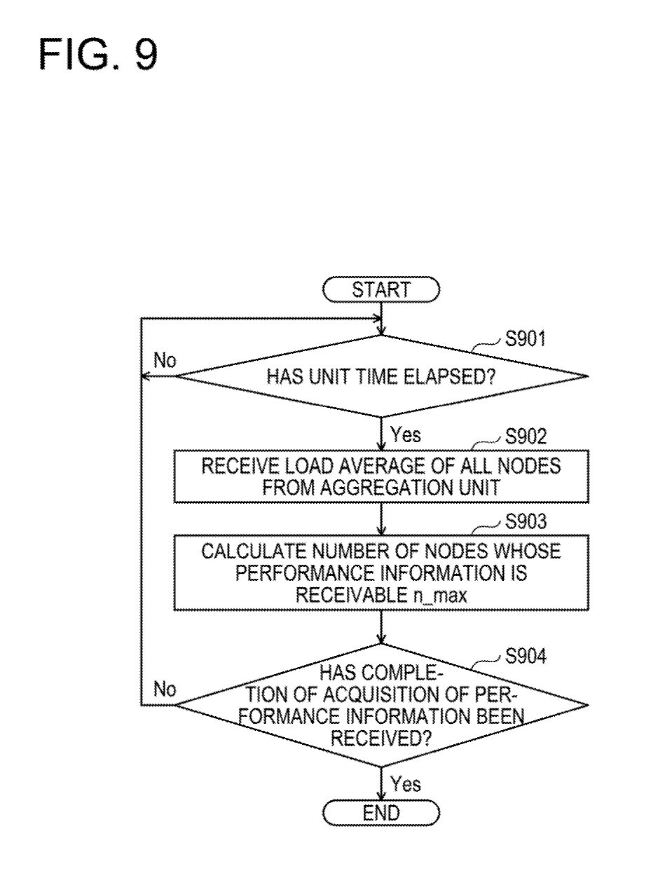

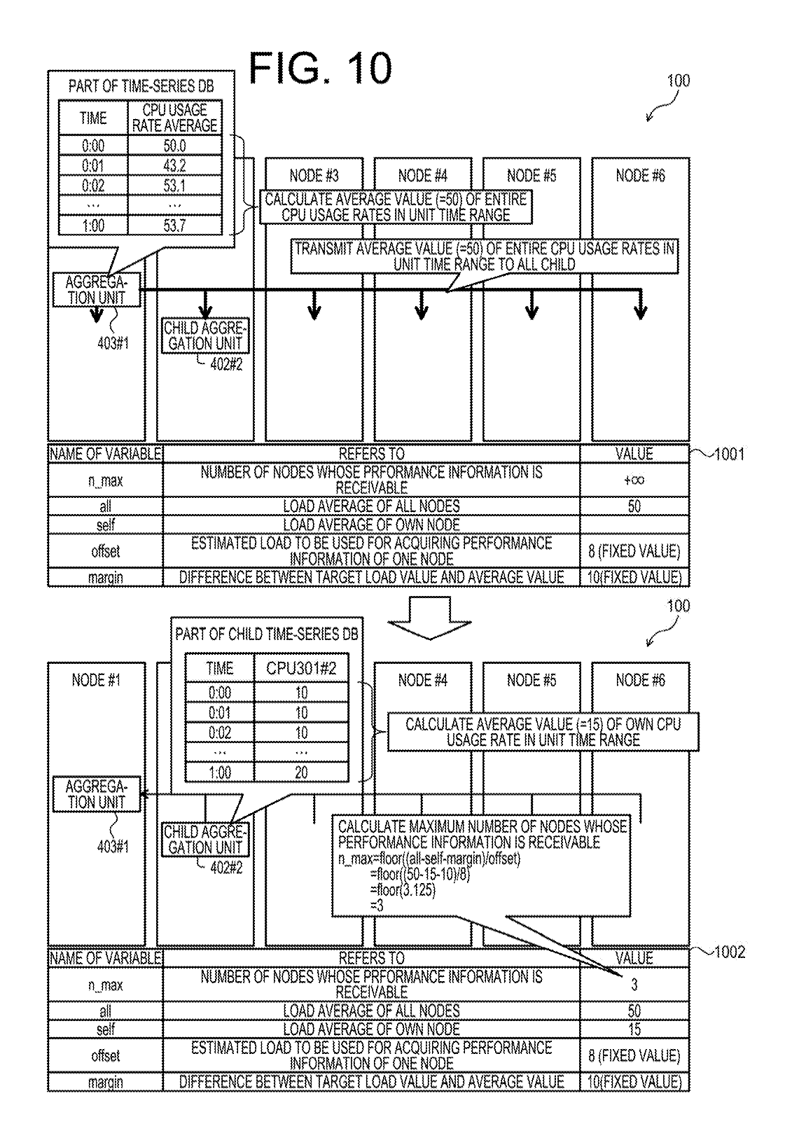

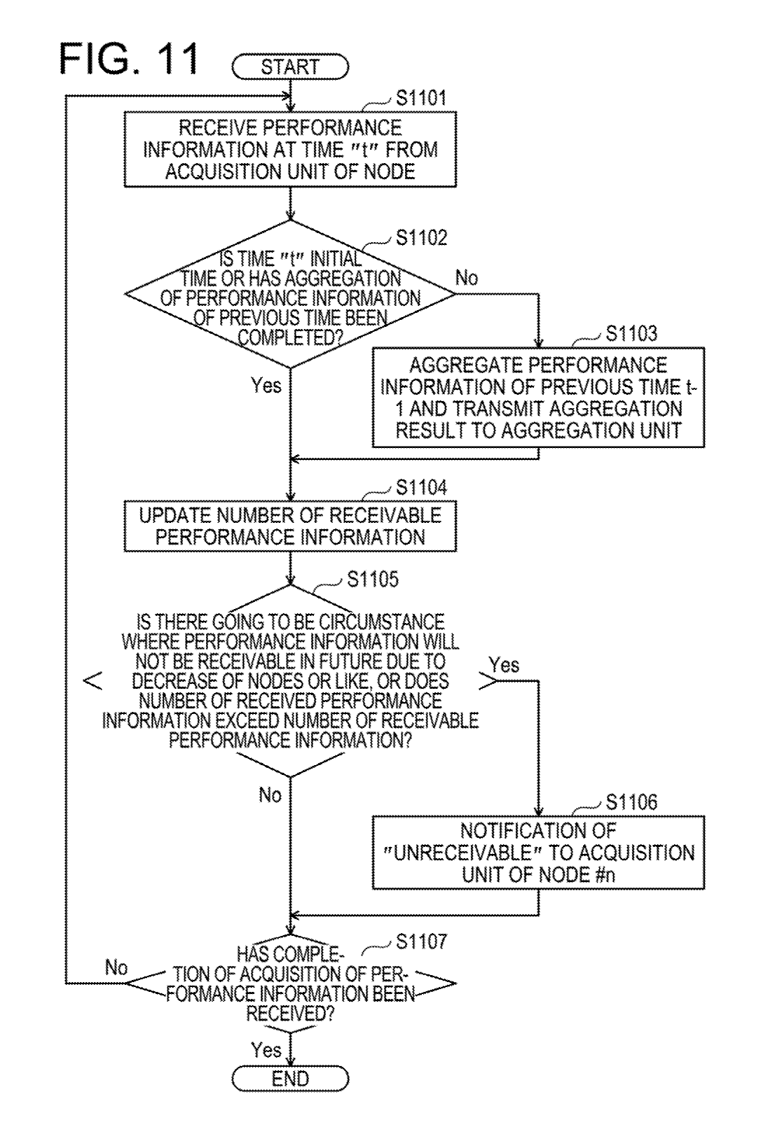

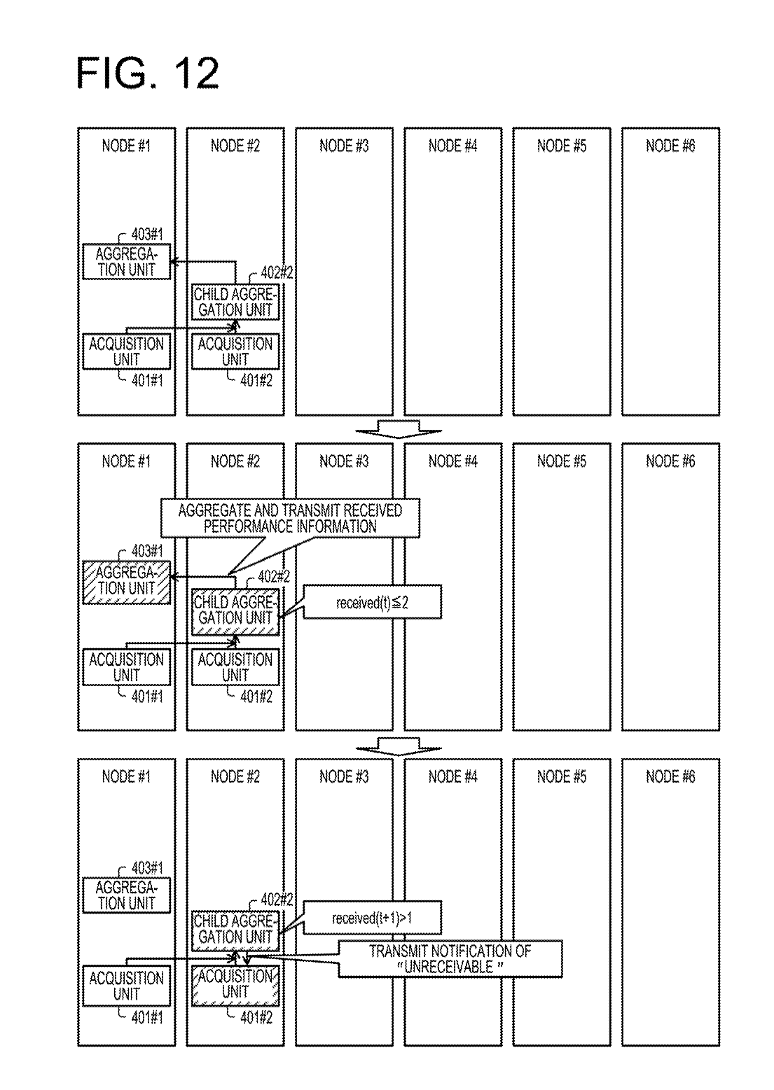

The child aggregation unit 402 executes a process of updating the number of receivable performance information and a process of receiving performance information. The process of updating the number of receivable performance information will be described using FIGS. 9 and 10, and the process of receiving performance information will be described using FIGS. 11 and 12.

FIG. 9 is a flowchart illustrating a procedure of the process of updating the number of receivable performance information by the child aggregation unit 402. The child aggregation unit 402 determines whether unit time has elapsed (step S901). The unit time may be any time interval and is, for example, 1 minute. When it is determined that the unit time has not elapsed (step S901: “No”), the process of step S901 is executed once more.

Meanwhile, when it is determined that the unit time has elapsed (step S901: “Yes”), the child aggregation unit 402 receives a load average of all the nodes from the aggregation unit 403#1 (step S902). The load average of all the nodes may be an average value of the CPU usage rates of all the nodes in the information processing system 100 or an average value of the network usage rates of all the nodes in the information processing system 100. In addition, the aggregation unit 403#1 periodically transmits the load average of all the nodes to all the nodes.

Next, the child aggregation unit 402 calculates the maximum number of nodes whose performance information is receivable, that is, the number of receivable performance information “n_max” (step S903). Specifically, the child aggregation unit 402 calculates “n_max” by executing the following equation (2).

n_max=floor((all-self-margin)/offset) (2)

Here, the initial value of “n_max” is, for example, a positive infinite value. In addition, floor( ) is a function to return a numerical value of a factor to a maximum, value of integers less than or equal to the factor. In addition, “all” is a load average of all the nodes. “Self” is a load average of an own node. In addition, “margin” is an estimated load to be used for collecting performance information of one node, “Offset” is a difference between a target load width to and an average value. The “all” is a value obtained in step S902, and the “self” is a value obtained from the child time-series DB 421. The “margin” may be a value obtained by substituting a CPU usage rate used for collecting performance information of one node as a result of preliminary measurement, or a value predetermined by the manager of the information processing system 100 or the like. The “offset” is, for example, a value predetermined by the manager of the information processing system 100 or the like.

Then, the child aggregation unit 402 determines whether completion of the acquisition of the performance information has been received from the user terminal 201 (step S904). When it is determined that completion of the acquisition of the performance information has not been received from the user terminal 201 (step S904: “No”), the child aggregation unit 402 proceeds to the process of step S901. Meanwhile, when it is determined that completion of the acquisition of the performance information has been received from the user terminal 201 (step S904: “Yes”), the child aggregation unit 402 ends the process of updating the number of receivable performance information.

FIG. 10 is an explanatory view illustrating an example of an operation of the process of updating the number of receivable performance information by the child aggregation unit 402. In FIG. 10, descriptions will be made on an operation of the process of updating the number of receivable performance information illustrated in FIG. 9. In FIG. 10, it is assumed that an average value of CPU usage rates is used as a load average. In addition, in FIG. 10, descriptions will be made with an example where the child aggregation unit 402#2 executes the process of updating the number of receivable performance information.

The upper part of FIG. 10 represents the state of the information processing system 100 when the child aggregation unit 402 executes the process of step S902. The aggregation unit 403#1 calculates an average value of entire CPU usage rates in a unit time range, and transmits the calculated average value of the entire CPU usage rates to all the child aggregation units 402. Each child to aggregation unit 402 receives the average value of the entire CPU usage rates. For example, the aggregation unit 403#1 obtains 50 as the average value of the entire CPU usage rates, and transmits 50 to the child aggregation units 402#1 to 402#6. The child aggregation units 402#1 to 402#6 receive the average value 50.

The table 1001 illustrated in FIG. 10 represents a list of the factors and the returned values of the equation (2) after the child aggregation unit 402#2 executes the process of step S902. As represented in the table 1001, the value of the “all” which is one of the factors of the equation (2) is determined by receiving the average value 50.

The lower part of FIG. 10 represents the state of the information processing system 100 when the child aggregation unit 402 executes the process of step S903. The child aggregation unit 402#2 calculates an average value of its CPU usage rate in a unit time range from the child time-series DB 521, and obtains the value of the “self” which is one of the factors of the equation (2). Then, the child aggregation unit 402#2 executes the equation (2) to obtain the value of “n_max.” For example, the child aggregation unit 402#2 obtains 15 as the average value of its CPU usage rate.

The table 1002 illustrated in FIG. 10 represents a list of the factors and the returned values of the equation (2) after the child aggregation unit 402#2 executes the process of step S903. As represented in the table 1002, the value of the “self” which is one of the factors of the equation (2) is determined by obtaining the average value 15, and “n_max” is calculated by the equation (2) as follows:

n_max=floor((all-self-margin)/offset)←n_max=floor((50−15−10)/8)=floor(3.125)=3

FIG. 11 is a flowchart illustrating a procedure of the process of receiving performance information by the child aggregation unit 402. The child aggregation unit 402 receives performance information at time “t” from the acquisition unit 401 of a node #n (step S1101). Next, the child aggregation unit 402 determines whether the time “t” is initial time or aggregation of performance information at previous time has been completed (step S1102).

When it is determined that the time “t” is not initial time, and aggregation of performance information at previous time has not been completed (step S1102: “No”), the child aggregation unit 402 aggregates the performance information of the previous time t−1, and transmits the aggregated performance information to the aggregation unit 403#1 (step S1103). As the process of step S1103, specifically, the child aggregation unit 402 executes aggregated (t−1)=true. Here, aggregated (t) is a flag of completion of collection of the performance information of the time “t.” The initial value of aggregated (t) is false.

When it is determined that the time “t” is initial time or aggregation of the performance information of the previous time has been completed (step S1102: “Yes”), or after the process of step S1103 is ended, the child aggregation unit 402 updates the number of the receivable performance information (step S1104). As the process of step S1104, specifically, the child aggregation unit 402 executes received (t)=received (t)+1. Here, “received (t)” is the number of the received performance information at time “t” The initial value of the received (t) is 0.

Next, the child aggregation unit 402 determines whether there is going to be a circumstance where performance information will not be receivable in the future due to decrease of nodes or the like, or the number of received performance information exceeds the number of receivable performance information (step S1105). As the process of step S1105, the child aggregation unit 402 determines that there is going to be a circumstance where performance information will not be receivable in the future, in a case where a command to reserve the decrease of nodes is received from the user terminal 201, for example, because the user performs a repair of the nodes. In addition, as to whether the number of received performance information exceeds the number of receivable performance information, the child aggregation unit 402 determines to that the number of received performance information exceeds the number of receivable performance information, in a case where received(t)>n_max.

When it is determined that there is going to be a circumstance where performance information will not be receivable in the future due to decrease of nodes or the like, or the, number of received performance information exceeds the number of receivable performance information (step S1105: “Yes”), the child aggregation unit 402 makes the notification of “unreceivable” to the acquisition unit of the node #n (step S1106).

When it is determined that there is not going to be a circumstance where performance information will not be receivable in the future due to decrease of nodes or the like, or the number of received performance information is equal to or less than the number of receivable performance information (step S1105: “No”), or after the process of step S1106 is ended, the child aggregation unit 402 determines whether completion of the acquisition of the performance information has been received from the user terminal 201 (step S1107). When it is determined that completion of the acquisition of the performance information has not been received from the user terminal 201 (step S1107: “No”), the child aggregation unit 402 proceeds to the process of step S1101. Meanwhile, when it is determined that completion of the acquisition of the performance information has been received from the user terminal 201 (step S1107: “Yes”), the child aggregation unit 402 ends the process of receiving the performance information.

FIG. 12 is an explanatory view illustrating an example of an operation of the process of receiving the performance information by the child aggregation unit 402. In FIG. 12, the child aggregation unit 402#2 which is a process subject and the functional units which are process target are indicated in white texts with black backgrounds. In addition, in FIG. 12, as represented in the upper part of FIG. 12, it is assumed that the acquisition units 401#1 and 401#2 transmit the performance information to the child aggregation unit 402#2.

The middle part of FIG. 12 represents a state where “n_max” of the child aggregation unit 402#2 is 2, and the child aggregation unit 402#2 receives the performance information from the acquisition units 401#1 and 401#2 at a certain time “t.” In this case, in the process of step S1105, received(t)=2≤2. Thus, the child aggregation unit 402#2 determines that step S1105: “No.” Then, in step S1103, the child aggregation unit 402#2 aggregates the performance information of the time “t,” and transmits the aggregated performance information to the aggregation unit 403#1.

The lower part of FIG. 12 represents a state where “n_max” of the child aggregation unit 402#2 becomes 1 due to increase of the load of the child aggregation unit 402#2, and the child aggregation unit 402#2 receives the performance information from the acquisition unit 401#2 after receiving the performance information at time t+1 from the acquisition unit 401#1. In this case, in the process of step S1105, received(t)=2>1. Thus, the child aggregation unit 402#2 determines that step S1105: “Yes.” Then, in step S1106, the child aggregation unit 402#2 makes the notification of “unreceivable” to the acquisition unit 401#2 of the node #2.

As described above, in the embodiment of the present disclosure, each node transmits the performance information 112 to the first node, and transmits the performance information 112 to the second node different from the first node when the notification of unreceivable is received. Thus, each node is capable of dynamically changing a node for executing the child aggregation unit 402.

In the embodiment of the present disclosure, when the performance information 112 is received from the third node, each node determines whether to transmit the notification of “unreceivable” to the third node, based on the number of receivable performance number and the number of received performance information. Thus, when the load of each node is high, the node may not execute the aggregation of the performance information 112 to of the third node so that the load may be suppressed from being further increased.

In the embodiment of the present disclosure, each node may calculate the number of receivable performance information based on a difference between an average value of the loads of all the nodes and an average value of the load of its own node. Thus, it is possible to cause a node having a low load in the information processing system 100 to aggregate the performance information 112, so that load distribution to balance the loads of the respective nodes may be implemented.

In the embodiment of the present disclosure, when the notification of “unreceivable” is received from the first node, each node may transmit the performance information 112 to a node whose node number is next or previous to that of the first node, as the second node. Thus, each node may suppress an occurrence of a node having no opportunity to transmit the performance information 112, among the plurality of nodes. Specifically, in the equation (1), 1 is added. However, when a value having a divisor of the number of the nodes of the information processing system 100, in other words, a number which is not prime to the number of the nodes of the information processing system 100 is added, a node having no opportunity to transmit the performance information 112 occurs among, the plurality of nodes. In addition, when a number, other than 1, which is prime to the number of the nodes of the information processing system 100 is added, it is possible to suppress the occurrence of a node having no opportunity to transmit the performance information 112 as long as the number of the nodes of the information processing system 100 does not change. However, the number of the nodes of the information processing system 100 is a value varying depending on increase or decrease of the nodes, and a node having, no opportunity to transmit the performance information 112 may occur among the plurality of nodes, Thus, by transmitting the performance information 112 to a node whose node number is next or previous to that of the first node, as the second node, each node may suppress the occurrence of a node having no opportunity to transmit the performance information 112 among the plurality of nodes.

The information processing method described in the embodiment of the present disclosure may be implemented by causing a computer such as a personal computer or a workstation to execute prepared programs. The information processing program of the present disclosure is stored in a computer-readable recoding medium such as a compact disc-read only memory (ROM) or a digital versatile disk (DVD), and executed when the program is read from the recording medium by the computer, Further, the information processing program of the present disclosure may be distributed via a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention, Although the embodiments of the present invention have been described in detail, it should be understood that the various changes, substitutions, and alterations could be made hereto without departing from the spirit and scope of the invention.

What is claimed is:

1. An information processing apparatus included in an information processing system which is constructed with a plurality of information processing apparatuses and configured to aggregate state, information indicating a state of each of the plurality of information processing apparatuses which is acquired by the each information processing apparatus the information processing apparatus comprising:
a memory; and
a processor coupled to the memory and the processor configured to:
transmit the state information of the each information processing apparatus to a first information processing apparatus which is one of the plurality of information processing apparatuses; and
transmit the state information of the each information processing apparatus to a second information processing apparatus different from the first information processing apparatus among the plurality of information processing apparatuses, when a notification indicating that an aggregation process of aggregating the state information of the each information processing apparatus is not executable is received from the first information processing apparatus.

2. The information processing apparatus according to claim 1, wherein the each information processing apparatus stores a number of state information receivable for executing the aggregation process, which corresponds to a load of the each information processing apparatus,
when state information of a third information processing apparatus which is one of the plurality of information processing apparatuses is received from the third information processing apparatus, the processor determines whether an aggregation process of aggregating the state information of the third information processing apparatus is executable, based on the number of the state information receivable for executing the aggregation process, which corresponds to the load of the each information processing apparatus at the receiving time of the state information of the third information processing apparatus, and a number of received state information, and
when it is determined that the aggregation process of aggregating the state information of the third information processing apparatus is not executable, the processor transmits a notification indicating that the aggregation process of aggregating the state information of the third information processing apparatus is not executable to the third information processing apparatus.

3. The information processing apparatus according to claim 2, wherein the state information includes load information indicating the load of the each information processing apparatus,
when an average value of loads of the plurality of information processing apparatuses is received from an information processing apparatus storing a process result of the aggregation process of aggregating the state information of the each information processing apparatus, the processor calculates the number of the state information receivable for executing the aggregation process based on a difference between the average value of the loads of the plurality of information processing apparatuses and the load of the each information processing apparatus, and
when the state information of the third information processing apparatus is received from the third information processing apparatus, the processor determines whether the aggregation process of aggregating the state information of the third information processing apparatus is executable, based on the calculated number of the state information receivable for executing the aggregation process and the number of received state information.

4. The information processing apparatus according to claim 1, wherein the each information processing apparatuses is associated with a number for identifying the each information processing apparatus,
when the notification indicating that the aggregation process of aggregating the state information of the each information processing apparatus is not executable is received from the first information processing apparatus, the processor transmits the state information of the each information processing apparatus to an information processing apparatus associated with a number next or previous to a number of the each information processing apparatus, as the to second information processing apparatus.

5. An information processing system which is constructed with a plurality of information processing apparatuses and configured to aggregate state information indicating a state of each of the plurality of information processing apparatuses, which is acquired by the each information processing apparatus,
wherein the each information processing apparatus stores a number of state information receivable for executing an aggregation process of aggregating the state information of the each information processing apparatus, which corresponds to a load of the each information processing apparatus, and transmits the state information of the each information processing apparatus to a first information processing apparatus which is one of the plurality of information processing apparatuses,
when the state information of the each information processing apparatus is received from the each information processing apparatus, the first information processing apparatus determines whether the aggregation process of aggregating the state information of the each information processing apparatus is executable, based on the number of the state information receivable for executing the aggregation process which corresponds to the load of the each information processing apparatus at a receiving time of the state information of the each information processing apparatus and a number of received state information,
when the aggregation process of aggregating the state information of the each information processing apparatus is not executable, the first information processing apparatus transmits a notification indicating that the aggregation process of aggregating the state information of the each information processing apparatus is not executable, to the each information processing apparatus, and
when the notification indicating that the aggregation process of aggregating the state information of the each information processing apparatus is not executable is received from the first information processing apparatus, the each information processing apparatus transmits the state information of the each information processing apparatus to a second information processing apparatus different from the first information processing apparatus among the plurality of information processing apparatuses.

6. The information processing system according to claim 5, wherein the state information includes load information indicating the load of the each information processing apparatus,
when an average value of loads of the plurality of information processing apparatuses is received from an information processing apparatus storing a process result of the aggregation process of aggregating the state information of the each information processing apparatus, the first information processing apparatus calculates the number of the state information receivable for executing the aggregation process, based on a difference between the average value of the loads of the plurality of information processing, apparatuses and the load of the each information processing apparatus,
when the state information of the each information processing apparatus is received from the each information processing apparatus, the first information processing apparatus determines whether the aggregation process of aggregating the state information of the each information processing apparatus is executable, based on the calculated number of the state information receivable for executing the aggregation process and the number of received state information.

7. A non-transitory computer-readable recording medium having stored therein a program for causing an information processing apparatus to execute a process, the information processing apparatus included in an information processing system which is constructed with a plurality of information processing apparatuses and configured to aggregate state information indicating a state of to each of the plurality of information processing apparatuses which is acquired by the each information processing apparatus, and the process comprising:
transmitting the state information of the each information processing apparatus to a first information processing apparatus which is one of the plurality of information processing apparatuses, and
transmitting the state information of the each, information processing apparatus to a second information processing apparatus different from the first information processing apparatus among the plurality of information processing apparatuses, when a notification indicating that an aggregation process of aggregating the state information of the each information processing apparatus is not executable is received from the first information processing apparatus.

8. The non-transitory computer-readable recording medium according to claim 7, the process further comprising:
storing a number of state information receivable for executing the aggregation process, which corresponds to a load of the each information processing apparatus; and
when state information of a third information processing apparatus which is one of the plurality of information processing apparatuses is received from the third information processing apparatus, determining whether an aggregation process of aggregating the state information of the third information processing apparatus is executable, based on the number of the state information receivable for executing the aggregation process, which corresponds to the load of the each information processing apparatus at a receiving time of the state information of the third information processing apparatus, and a number of received state information; and
when the aggregation process of aggregating the state information of the third information processing apparatus is not executable, transmitting a notification indicating that the aggregation process of aggregating the state information of the third information processing apparatus is not executable, to to the third information processing apparatus.
